(19) United States
(12) Patent Application Publication
(10) Pub. No.: US 2003/0151527 A1
(43) Pub. Date: Aug. 14, 2003

(54) Portable attitude indicator

(76) Inventor: Roger S. Gilbert, El Cajon, CA (US)

Correspondence Address: Roger S. Gilbert, 1306 Petree St. 479, El Cajon, CA, 92020, US

(21) Appl. No.: 10/358,566

(22) Filed: Feb. 5, 2003

Related U.S. Application Data
(60) Provisional application No. 60/356,509, filed on Feb. 13, 2002.

(51) Int. Cl. G01C 21/00

(52) U.S. Cl. 340/974

(57) ABSTRACT

To provide a small portable, (not permanently fixed or mounted in panel of Aircraft) dual power source, independent aircraft attitude indicator, to be used as a back up to the main vacuum driven indicator in light to medium general aviation aircraft. The purpose would be to facilitate control or navigation of the aircraft in case of a vacuum pump failure to the main indicator. The unit size would be approximately 3 by 5 inches and would be composed of the following.

(A) A gyroscope either in chip or mechanical form.

(B) An internal and external power source.

(C) A means of displaying attitude indication, such as L.E.D. crystal display or or other means.

(D) A way for mounting the Portable Attitude Indicator to cockpit panel or yoke of the aircraft.

(E) All internal mechanical and electrical components to allowing for the interface of internal components to external viewing.

(F) Portability and independence of the above unit and its components from the aircraft's systems.

### RELATED APPLICATIONS

This application claims the benefit of priority from U.S. Provisional Patent Application No. 60/356,509 entitled “Portable Attitude Indicator” filed on Feb. 13, 2002 and currently co-pending.

### DESCRIPTION

The Portable Attitude Gyro by Roger S. Gilbert is an original concept and patent which was first reserved in witnessed form in or around 1983 and is being revisited now Jan 1, 2002. Concept: To provide a small portable, not permanently mounted in panel (previous art) dual power source, independent aircraft attitude indicator, that can be used as a back up to the main vacuum driven indicator in light to medium general aviation aircraft. The purpose would be to facilitate control or navigation of the aircraft in case of a vacuum pump failure to the main attitude indicator. The unit size would be approximately 3 by 5 inches and would be composed of the following.

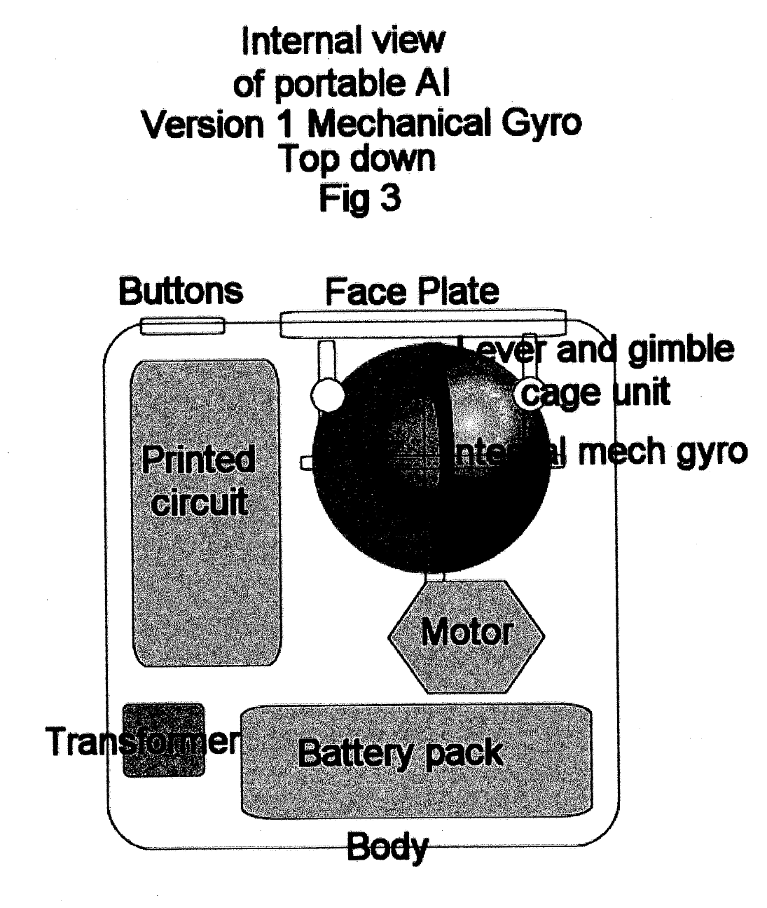

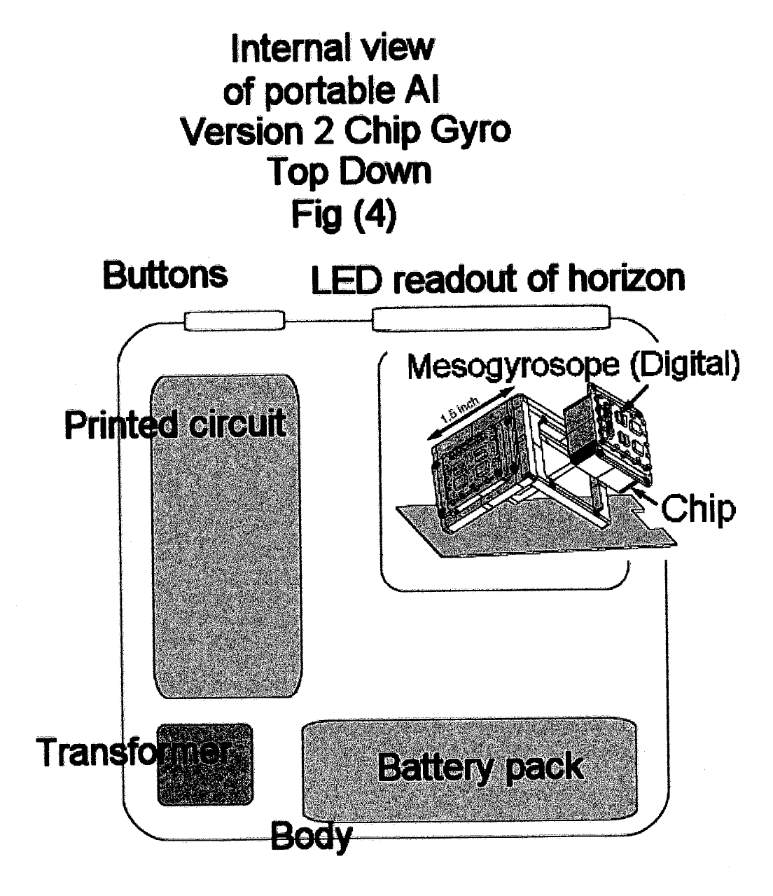

Description of figures Internal: Miniature gyro in either silicon chip form (see drawings page 3, FIG. 4) or actual miniature mechanical gyro (see drawings page 2 FIG. 3). Internal replaceable or rechargeable battery as one power source (see drawings pages 2,3, FIG. 3, 4). Apparatus consisting of power reduction transformer (see drawings pages 2,3, FIG. 3, 4) connecting power source to gyro motor (see drawings pages 2,3, FIG. 3, 4).

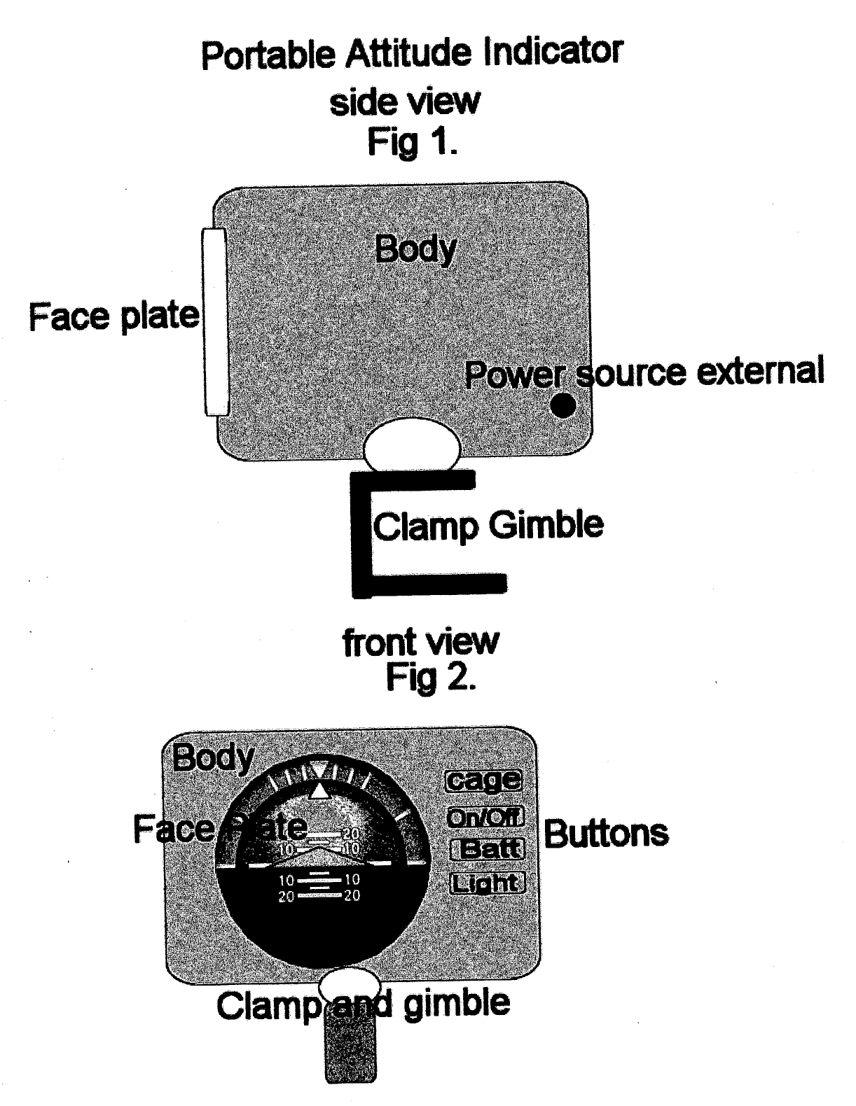

Apparatus consisting of small levers and gimbles connecting gyro to face of attitude Indicator, (see drawings page 2 FIG. 3) or actual viewing surface (miniature airplane on artificial horizon with degree marks) described as face or face plate (see drawings pages 2, FIG. 3,). Alternative could be a solid state connection from a mesogyrosope (gyroscope in chip form) to a l.e.d. read out of a horizon (see drawings pages 3, FIG. 4). Small transformer with which to transform electrical current from external and internal source. Small display light attached to power source and reflected upon face of PAI. All internal electronic parts, such as printed circuit boards and wires for interfacing the mesogyroscope (chip Gyro unit) with the L.E.D. readout, and the control buttons with the power and display units (both units). Description of figures External: Plugs for second external power source ie cigarette lighter or other source (see page 1, FIG. 1) Plug for recharging (see page 1, FIG. 1). On off, standby, cage, light and battery power source switches. (see page 1, FIG. 1) Transparent face plate or led for attitude display (see page 1, FIG. 1). AC or DC cord for connecting unit to external source. Small clamp gimbal or other device for affixing the device to the panel. (see page 1, FIG. 1). This invention could be incorporated with another portable device such as GPS. Avionics etc.

Operation

When getting into his aircraft the pilot would take the Portable Attitude Gyro out of his flight bag and attach it to the panel of his aircraft. He would then choose which power option to use. Either by plugging into an external source such as a cigarette lighter or using the internal battery switch. He would then cage the unit (puts the airplane in the appropriate place on the artificial horizon face plate) by pushing the cage button, and if traveling at night push the light button. If his plane then has a vacuum failure and his main attitude indictor failed he would be perfectly set to navigate and keep the aircraft upright with his back up or portable attitude indicator.

Commentary on Need and Purpose

Every year hundreds of general aviation pilots in light to medium aircraft, die because of a condition that arises out of loss of their attitude indicator (AI) due to engine driven vacuum pump failure (The vacuum or air being the source of power for the AI.) The AI or artificial horizon is critical to the pilot keeping his bearings, while flying in the clouds or Instrument Meteorological Conditions known as IMS. A perfect remedy to this Situation would be to have a back up AI driven by a source other then the vacuum system and independent of the aircraft's systems altogether for the ultimate redundancy. Namely an electrical source. This is where the portable attitude indicator (PAI) comes into the picture. Not only is it portable so it can be carried from aircraft to aircraft but it operates on battery or external power, say from a cigarette lighter and can be easily mounted on the panel via a clamping type swivel gimbal. If the vacuum system fails the pilot need only flip a switch on PAI to enable him to view It, thus escaping a critical situation. This situation as described above has been a problem for years and every attempt is made to train pilots how to fly with just a part of the panel or partial panel. This invention would save thousands of lives.

1. I claim a portable attitude indicator comprised of the following:
(A) A gyroscope either in chip or mechanical form.
(B) An internal and external power source.
(C) A means of displaying attitude indication, such as L.E.D. crystal display or or other means.
(D) A way for mounting the Portable Attitude Indicator to cockpit panel or yoke of the aircraft.
(E) All internal mechanical and electrical components to allowing for the interface of internal components to external viewing.
(F) Portability and independence of the above unit and its components from the aircraft's systems.
